(19) United States
(12) Patent Application Publication
(10) Pub. No.: US 2009/0327766 A1
(43) Pub. Date: Dec. 31, 2009

(54) Power Over Ethernet Reclassification

(76) Inventors: Sajol Ghoshal, El Dorado Hills, CA (US); Abbas Hage, Atherton, CA (US); John Camagna, El Dorado Hills, CA (US); Philip John Crawley, Sacramento, CA (US)

Correspondence Address: KOESTNER BERTANI LLP, 2192 Martin St., Suite 150, Irvine, CA, 92612, US

(21) Appl. No.: 12/165,356

(22) Filed: Jun. 30, 2008

(51) Int. Cl. G06F 1/26

(52) U.S. Cl. 713/300

(57) ABSTRACT

A power over Ethernet (PoE) system has a reclassification functionality. The illustrative PoE system comprises a powered device (PD) and a power sourcing equipment (PSE) communicatively coupled to the PD. A classification identification component coupled to the PD encodes a classification value. A classification identification component can typically be implemented as a classification resistor, although any other suitable component such as a capacitor, inductor, register, or other structure or method can otherwise be implemented. The PoE system can further comprise a reclassification register in a non-volatile memory that stores a value indicative of a new classification state and a new classification identifier and a power switch that powers the powered device to a classification voltage. A PD controller is coupled to the powered device that reads the value indicative of the new classification state and, if the new classification state is asserted, reads the new classification identifier and sets classification according to the new classification identifier. If the new classification state is not asserted, the PD controller sets classification according to the classification identification component.

### BACKGROUND

Power over Ethernet (PoE) technology enables transmission of electrical power in combination with data to remote devices over standard twisted-pair cable in an Ethernet network. PoE is useful for powering devices and appliances such as Internet Protocol (IP) telephones, network cameras, wireless local area network (LAN) access points, embedded computers, remote network switches, and the like to improve convenience, reduce expense, and enhance system flexibility.

PoE technology is compliant with IEEE 802.3 standard which describes two types of devices including power sourcing equipment (PSE) and powered devices (PD) wherein power sourcing equipment supplies power to the powered devices. IEEE 802.3af-2003 describes five power classes at which a PD can be powered for PSEs and PDs that support classification.

### SUMMARY

An embodiment of a power over Ethernet (PoE) system has a reclassification functionality. The illustrative PoE system comprises a powered device (PD) and a power sourcing equipment (PSE) communicatively coupled to the PD. A classification identification component coupled to the PD encodes a classification value. A classification identification component can typically be implemented as a classification resistor, although any other suitable component such as a capacitor, inductor, register, or other structure or method can otherwise be implemented. The PoE system can further comprise a reclassification register in a non-volatile memory that stores a value indicative of a new classification state and a new classification identifier and a power switch that powers the powered device to a classification voltage. A PD controller is coupled to the powered device that reads the value indicative of the new classification state and, if the new classification state is asserted, reads the new classification identifier and sets classification according to the new classification identifier. If the new classification state is not asserted, the PD controller sets classification according to the classification identification component.

### BRIEF DESCRIPTION OF THE DRAWINGS

Embodiments of the invention relating to both structure and method of operation may best be understood by referring to the following description and accompanying drawings:

FIGS. 1A and 1B are schematic block diagrams respectively depicting non-isolated and isolated embodiments of power over Ethernet (PoE) systems that include reclassification functionality;

FIGS. 2A through 2C are flow charts showing one or more embodiments or aspects of a reclassification technique for determining a power level classification for a powered device (PD) coupled to a power sourcing equipment (PSE) in a power over Ethernet (PoE) system;

FIG. 3, a schematic block diagram illustrates another embodiment of a power over Ethernet (PoE) system with reclassification functionality; and

FIG. 4 is a flow chart showing an embodiment or aspect of a reclassification technique for determining a power level classification for a powered device (PD) coupled to a power sourcing equipment (PSE) in a power over Ethernet (PoE) system; and

FIGS. 5A and 5B are schematic block diagrams depicting other embodiments of a power over Ethernet system that uses a capacitor as a memory element.

### DETAILED DESCRIPTION

In a typical PoE system, classification is a physical layer protocol that is performed at initialization of the powered device (PD). The power sourcing equipment (PSE) and PD perform the protocol at initialization to determine the amount of power suitable for operation of the PD. One difficulty is that the system may include one or more modular powered devices, for example plug-in modules, to enable additional functionality after the PD is already operating. For example, the PD can be a Voice over Internet Protocol (VoIP) telephone and various modules for operations such as monitoring and management modules can be added after the PD is initialized. At set-up or initialization, the PD is set to draw a selected amount of power from the PSE based upon the PD power classification. The set amount is selected that is sufficient to enable operation of the PD. If one or more plug-in modules are attached to the PD and the module(s) is configured to receive power from the PoE device, the combined power draw of the PD and added module can be greater than the amount of power allocated that is sufficient to operate the PD alone. To avoid powering the plug-in module(s) from a local power supply and the associated inconvenience of connecting addition equipment such as power transformer and cord, powering the module(s) from the PSE is desirable.

One difficulty is that classification at initial power-up can result in application of insufficient power to the PD after a module is added if the classification is set according to PD conditions at initialization. If classification is set anticipating addition of modules, classification can be set to high. What is desired is a technique for reclassification as modules are added or removed.

A traditional PoE system only determines power classification at initial power-up. When power is applied, the initial voltage is zero and then increases to about 2.5 to 5 volts at which a classification resistor (RClass) is accessed to determine classification. For example, for a classification resistor the power sourcing equipment (PSE) can enter a classification state for measuring the power level class indicated by the resistor and applies a voltage of 14.5 to 20.5 volts as specified by 802.3af to the powered device (PD). The PD responds by sending a current back to the PSE based on and indicative of one of the five classes including class 0 (default) with 0.44 to 12.94 watt maximum power levels at the input terminal of the powered device; class 1 (optional) at 0.44 to 3.84 watts; class 2 (optional) at 3.84 to 6.49 watts; class 3 (optional) at 6.49 to 12.95 watts; and class 4 (reserved) with PSEs classified as class 0. So most of these Voice over IP (VoIP) telephones want to be in the lowest possible class—which is primarily (usually) class 1—class 0 is to the full 15 watts, class 1 is four watts, class 2 is six and a half watts, class 3 is nine watts, and class 4 is reserved.

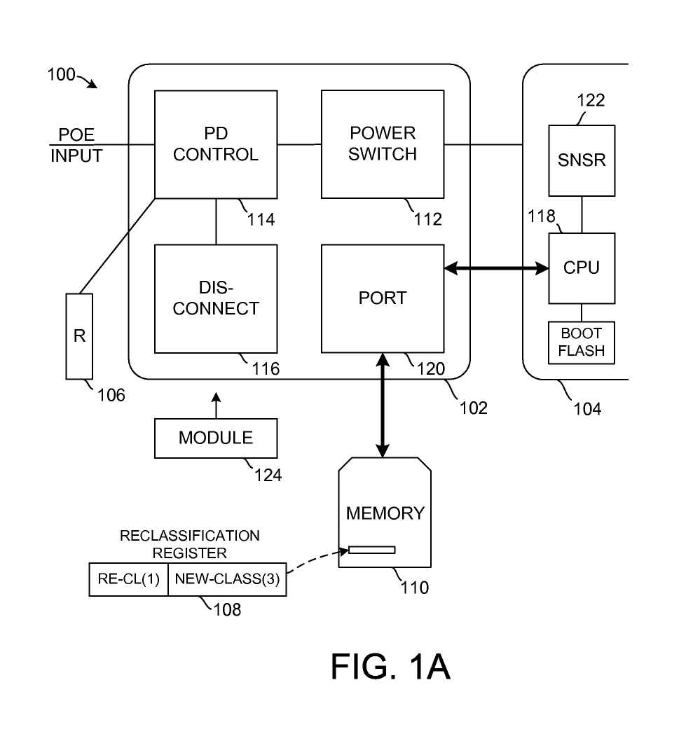

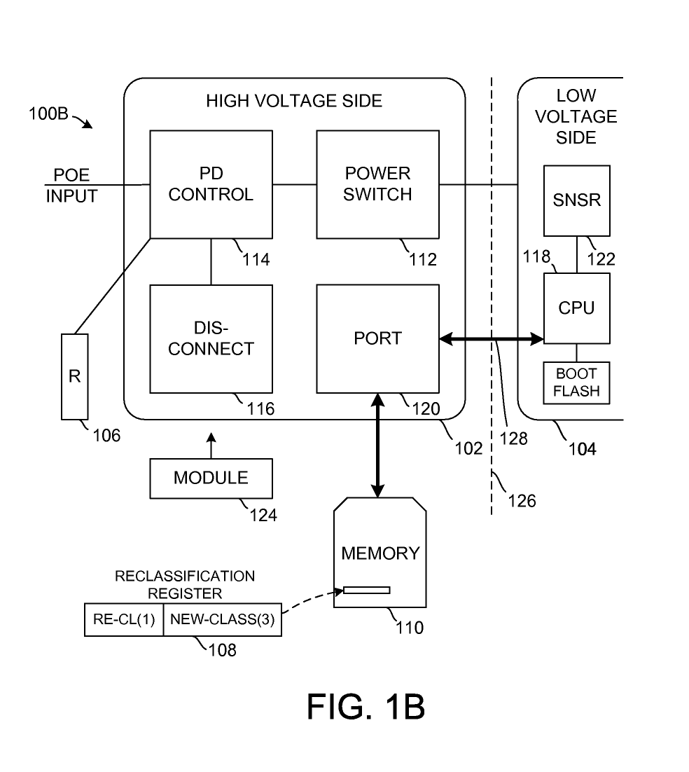

Referring to FIG. 1A, a schematic block diagram depicts an embodiment of a power over Ethernet (PoE) system 100 that includes reclassification functionality in a non-isolated form. The illustrative system 100 comprises a powered device (PD) 102 and a power sourcing equipment (PSE) 104 communicatively coupled to the PD 102. A classification identification component 106 coupled to the PD 102 encodes a classification value. A classification identification component 106 can typically be implemented as a classification resistor, although any other suitable component such as a capacitor, inductor, register, or other structure or method can otherwise be implemented. The PoE system 100 can further comprise a reclassification register 108 in a non-volatile memory 110 that stores a value indicative of a new classification state and a new classification identifier and a power switch 112 that powers the powered device 102 to a classification voltage. A PD controller 114 is coupled to the powered device 102 that reads the value indicative of the new classification state and, if the new classification state is asserted, reads the new classification identifier and sets classification according to the new classification identifier. If the new classification state is not asserted, the PD controller 114 sets classification according to the classification identification component 106.

In an example implementation, the non-isolated PoE system 100 can be a non-isolated circuit such as a buck converter. The buck converter is not operative and does not generate an output signal during the classification stage (14.5-20V) so that the nonvolatile memory 110 or flash enables setting of classification.

During operation, as power is initially applied to the PoE system 100 the voltage increases and the system passes through several operational stages including a signature recognition or classification stage. In the classification stage, the voltage is in a range between 14.5 and 20 volts, a voltage that is insufficient for powering circuits such as DCDC converter circuits. In a non-isolated PoE system 100, for example in a Buck converter configuration, the converter is not powered during the classification stage so that control circuitry such as logic or processors is inactive and cannot assist in the classification operation.

In some embodiments, the PoE system 100 can further comprise a disconnect device 116 coupled to the powered device (PD) controller 114 that disconnects power to the PD 102 under control of the PD controller 114. A processor 118 can be communicatively coupled to the PD 102. An interface port 120 in the PD 102 can be communicatively coupled between the processor 118 and the non-volatile memory 110.

The disconnect device 116 disconnects the PD 102 and then allow the PSE 104 to restart. Disconnecting the PD 102 is simple operation, for example dropping the current below 5 milliamps can cause the PD 102 to reduce the voltage to zero or nearly zero, and then restart.

The powered device (PD) controller 114 can perform several control operations. For example, the PD controller 114 can further reset the non-volatile memory 110 which is indicative of the new classification state after classification is set. In some embodiments, the PD controller 114 can further activate a disconnect cycle after the non-volatile memory 110 indicative of the new classification state is reset.

In embodiments with a processor 118 communicatively coupled to the PD 102, an interface port 120 in the PD 102 can be communicatively coupled between the processor 118 and the non-volatile memory 110. The processor 118 can set the memory indicative of the new classification state and the new classification identifier by communication through the PD 102 to the non-volatile memory 110.

A sensor 122 can be coupled to the processor 118 that detects connection of an additional module 124 to the powered device (PD) 102 during PD operation. The processor 118 can be responsive to the detected connection by requesting reclassification of the PD 102 wherein the reclassification register 108 is updated with the non-volatile memory 110 indicative of the new classification state asserted and the new classification identifier set.

The illustrative circuit and associated operating method can be used in either isolated or non-isolated applications. Referring to FIG. 1B, a schematic block diagram depicts an embodiment of an isolated PoE system 100B. The PoE system 100B can further comprise an isolation barrier 126 that isolates a high voltage from a low voltage (which is lower than the high voltage) wherein the powered device (PD) 102 and the non-volatile memory 110 are powered at the high voltage, and the power sourcing equipment (PSE) 104 is powered at the low voltage. In some implementations, a bidirectional signal pathway 128 across the isolation barrier 126 communicates a digital signal which includes, for example, at least classification control information. The isolation barrier 126 can be positioned at various locations in the PoE system 100, for example passing through the PD 102 so that some components are in a high-voltage section and other components in a low-voltage section.

The isolation barrier 126 and communication pathway 128 can take various forms. For example, opto-coupler or optical isolation, digital isolation, transformer-based isolation, capacitive isolation, and others. In the isolated configuration, digital communication across the transformer, capacitive, or other isolation barrier 126 or one or more opto-couplers and be used to enable communication across the isolation boundary 126.

Communication across the isolation boundary 126 enables writing of information for reclassification into the memory 110 or flash by the processor 118 or logic when the logic is powered during standard operation. The reclassification information in the memory 110 is accessed when the PoE system 100B is powered during the 14.5 to 20 volt range during classification.

In a particular embodiment, the PD controller 114 has an input line from a PoE signal and is connected to a classification resistor (RClass) which functions as the classification identification component 106. The illustrative interface port 120 can be an Inter-integrated Circuit (^{I2}C) multi-master serial computer bus which is typically used to connect low-speed peripherals to a device such as an embedded system, cellphone, motherboard, and the like. The ^{I2}C port 120 is connected to the non-volatile memory 110, illustratively a flash memory. The flash memory 110 holds the re-classification register 108 which includes a single-bit Re-CL(1) bit field for storing the value indicative of the new classification state and a three-bit New-Class(3) bit field for storing the new classification identifier.

During initial power-up, once the classification voltage is reached, the flash memory 110 is read. If the Re-CL(1) bit is set, then the classification current is set as “New-Class”, according to the code of the New-Class(3) bit field. Otherwise the external RClass 106 value is used for the classification current.

After classification, the Re-CL(1) bit is reset. The Re-CL(1) bit can be set by a microprocessor 118 through the I²C port 120 in combination with the New-Class(3) value.

Once the Re-CL(1) bit is set, the PD 102 takes the system 100 into a disconnect cycle for reclassification.

In an example reclassification operation for a PoE application of a cell phone, the PoE system 100 can initialize at the lowest power class with the phone set at lowest power such as class 1. The cell phone is configured with a capability to insert additional modules into a jack on the side of the phone, which is operational as a powered device 102. When the additional module 124 is attached, the power burden is increased and a suitable modification of power class is desirable, for example from class 1 to class 2, from class 1 to class 3, or any suitable combination of classes, to enable sufficient power to any adjunct module that is attached.

The illustrative PoE system 100 improves over a conventional system in which the PD on power-up accesses an RClass resistor that is wired to set the class of the PD and thus can only set one selected class. Thus, in the conventional system, if the RClass resistor sets the PD to class 1, whenever the system powers-up, the RClass resistor is read and the same class 1 power classification is imposed. In contrast, the illustrative PoE system 100 includes additional memory 110 and logic that enables issue of a different class on second and subsequent power-ups. The illustrative system includes a flash memory 100 that communicates with the PD 102 via an I²C interface 120 that may already be included on a PD integrated circuit chip for various operations. The PD 102 can communicate with a microprocessor 118, for example operating as a slave unit, or the microprocessor can have an attached flash memory.

Usage of the flash 110 for determining power class enables classification before the microprocessor 118 is powered. Thus, the flash memory 110 instructs the power switch 112 to determine classification before the microprocessor 118 becomes functional on application of power and before information can be sent by the microprocessor 118 to assist in classification.

In the illustrative embodiment, the flash memory 110 is located on the high-voltage side of the PoE system 100 and includes a register with a reclassification bit (Re-Cl(1)) and a new class field, for example with three bits (New-Class(3)) to select one of the four classes.

Thus, if a module 124 is jacked into the PD 102, the processor 118 can detect connection of the module 124 and performs operations to enable additional power application to the PD 102. The microprocessor 118 can send a command to the i²C interface 120 which initiates reclassification. For example, the command can request power-down reclassification and specify the class for operating the PD 102 after power-up. The I²C port 120 writes into the flash memory 110 and the reclassification register so set the reclassification bit Re-CL(1) to one and to identify the new class New-Class(3), for example so that the new selected class is class 2.

The PD 102 can be powered-down by driving or turning off the DCDC converter (not shown) in the PD 102 then turning off the power switch 112 and reducing the current to less than five milliamps. When the current is reduced below five milliamps, the PSE 104 restarts and increases the voltage up to 14.5 volts which is sufficient for functionality of the signature reclassification register 108. The voltage further increases to the range of 14.5 to 20.5 volts that is suitable for functionality of the flash memory 110. The flash memory 110 is read and the reclassification bit Re-CL(1) is determined to be set, thus requesting reclassification. Accordingly reclassification is set, not according to the classification resistor (RClass) but rather as determined by the New-Class(3) bits of the reclassification register 108. The PD 102 thus sends the current specified by the New-Class(3) bits back to the power switch 112. Thus, for example, the switch can select class 3, as indicated by the New-Class(3) bits, even though the Rclass resistor 106 specifies class 1.

To prevent permanent operation in the class according to the New-Class(3) bits, once the reclassification is complete and the classification change set, the PoE system 100 is reset and reclassification state resets so that upon the next power-up, the Re-CL(1) bit is reset to zero and classification is again determined according to the Rclass resistor 106.

In either the non-isolated PoE system 100 or the isolated PoE system 100B, FIGS. 1A and 1B depict a boot flash associated with the processor 118 to clarify that the memory 110, which may be a flash memory, is different from a typical bootstrap load flash memory. The memory 110 is distinguished from the flash memory associated with the processor 118 on the basis that the memory 110 is positioned on the powered device (PD) 102 and the flash memory is positioned on the power sourcing equipment (PSE) 104. Accordingly, during power-up the memory 110 is operational during classification while the flash memory associated with the processor 118 remains inactive since the processor 118 and associated circuitry on the PSE 104 are not operational in terms of supply voltage during the classification stage.

Thus, the PoE system 100 or 100B can be implemented with two flash memories. One flash memory, associated with the processor 118 is normally used for bootstrap loading under full power conditions but is nonoperational during the classification stage. The other memory 110, which can also be a flash memory, is operational when full power conditions are not present such as during the classification stage.

In the isolated PoE system 100B, the memory 110 on the high voltage side is operational during the classification stage while a flash memory associated with the processor 118 on the low voltage side is not operational.

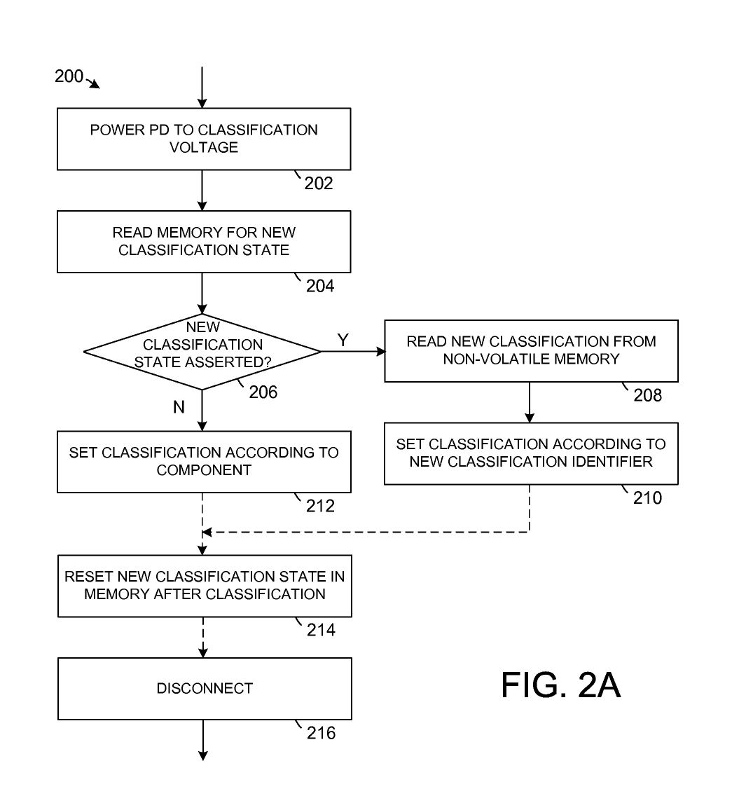

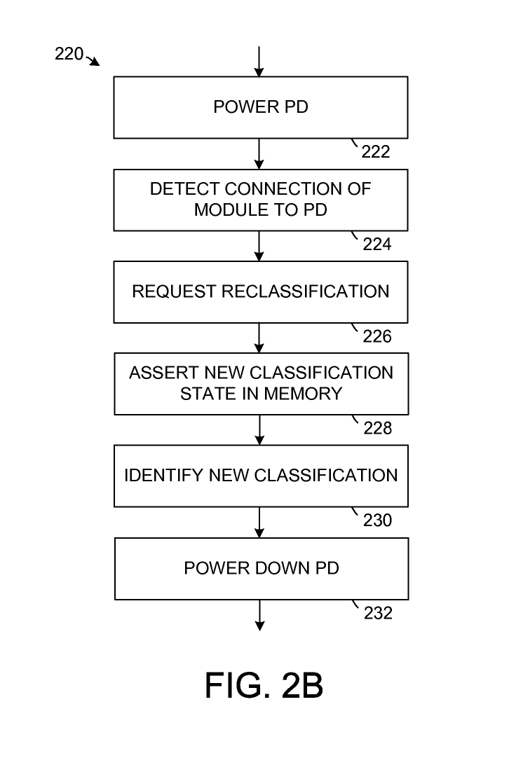

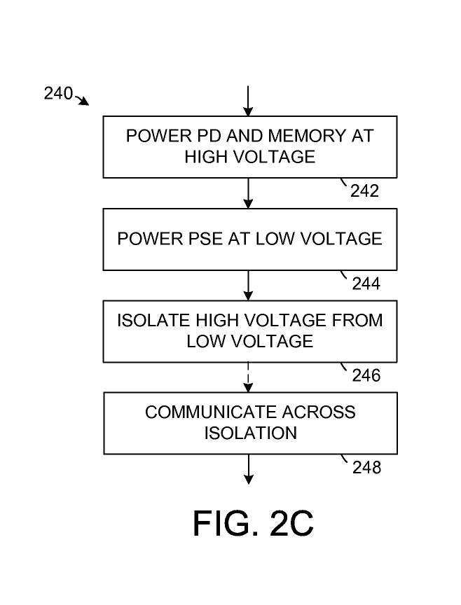

FIGS. 2A through 2C are flow charts showing one or more embodiments or aspects of a reclassification technique for determining a power level classification for a powered device (PD) coupled to a power sourcing equipment (PSE) in a power over Ethernet (PoE) system. Referring to FIG. 2A, the reclassification method 200 comprises powering 202 the powered device to a classification voltage and reading 204 a non-volatile memory indicative of a new classification state. If the new classification state is asserted 206, the method 200 comprises reading 208 a new classification from a non-volatile memory holding an identifier of the new classification and setting 210 classification according to the new classification identifier. If the new classification state is not asserted 206, classification is set 212 according to a classification identification component.

In some implementations, the non-volatile memory indicative of the new classification state can be reset 214 after classification is set.

A disconnect cycle can be performed 216 after the non-volatile memory indicative of the new classification state is reset.

The memory indicative of the new classification state and the new classification identifier can be set by communication through the powered device (PD) to the non-volatile memory.

Referring to FIG. 2B, a reclassification method 220 can comprise operating 222 the powered device (PD), detecting 224 connection of an additional module to the PD, and requesting 226 reclassification. The non-volatile memory indicative of the new classification state is asserted 228 and the non-volatile memory identifying the new classification set 230. The PD is then powered down 232.

Referring to FIG. 2C, according to an aspect 240 of a reclassification embodiment, the powered device (PD) and the non-volatile memory can be powered 242 at a high voltage and the power sourcing equipment (PSE) powered 244 at a low voltage that is lower than the high voltage. The high voltage can be isolated 246 from the low voltage at an isolation barrier.

A digital signal can be communicated 248 bidirectionally across the isolation barrier, the digital signal comprising at least classification control information.

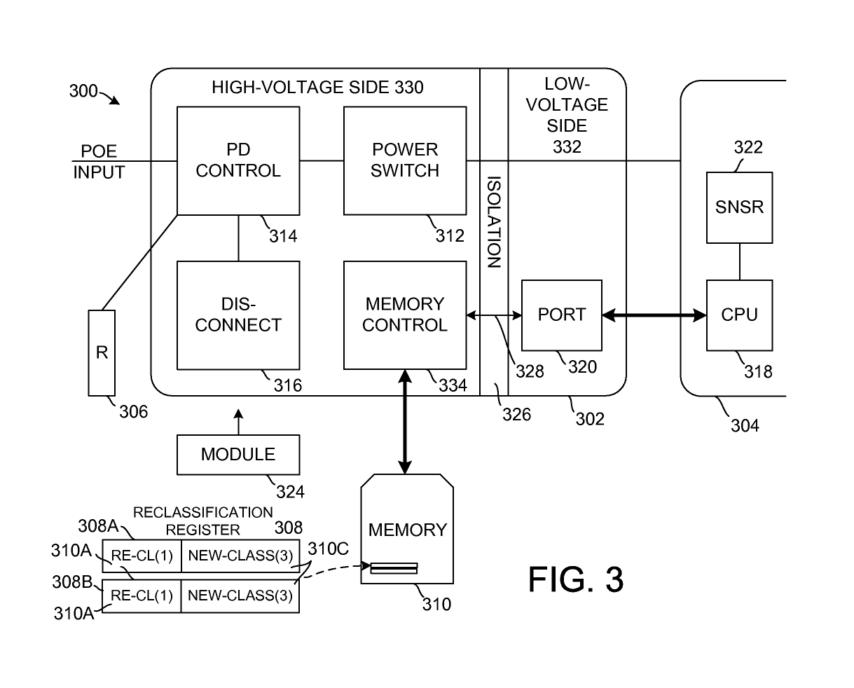

Referring to FIG. 3, a schematic block diagram illustrates another embodiment of a power over Ethernet (PoE) system 300 with a reclassification functionality. The illustrative PoE system 300 comprises a powered device (PD) 302, a power sourcing equipment (PSE) 304 which is communicatively coupled to the PD 302. The PoE system 300 further comprises several storage structures for implementing reclassification including a classification identification component 306, for example a classification resistor, coupled to the PD 302 that encodes a classification value, and a reclassification register 308 in a non-volatile memory 310 which stores a value 310A indicative of a new classification, a value 310B indicative of a new classification override, and a new classification identifier 310C. The PoE system 300 further comprises a power switch 312 that powers the powered device 302 to a classification voltage, and a PD controller 314 coupled to the powered device 302 that reads the value 310A indicative of the new classification state and, if the new classification state or the new classification override 310B is asserted, reads the new classification identifier 310C and sets classification according to the new classification identifier 310C. If the new classification state 310A is not asserted, the PD controller 314 sets classification according to the classification identification component 306.

In some implementations, the PoE system 300 can further comprise a disconnect device 316 coupled to the powered device (PD) controller 314 that disconnects power to the PD 302 under PD controller control and a processor 318 communicatively coupled to the PD 302. An interface port 320 in the PD 302 can be communicatively coupled between the processor 318 and the non-volatile memory 310. The processor 318 sets the memory 310A indicative of the new classification state, the new classification override 310B, and the new classification identifier 310C by communication through the powered device (PD) 302 to the non-volatile memory 310.

The powered device (PD) controller 314 can reset the non-volatile memory 310A indicative of the new classification state after classification is set and activate a disconnect cycle after the non-volatile memory 310A indicative of the new classification state is reset.

A sensor 322 coupled to the processor 318 detects connection of an additional module 324 to the powered device (PD) 302 during PD operation. The processor 318 responds to the detected connection by requesting reclassification of the PD 302 so that the reclassification register 308 is updated with the non-volatile memory indicative of the new classification state 310A asserted and the new classification identifier 310C set.

The PoE system 300 can further comprise an isolation barrier 326 for isolating a high voltage from a relatively lower voltage so the powered device (PD) 302 and the non-volatile memory 310 are powered at the high voltage and the power sourcing equipment (PSE) 304 is powered at the lower voltage. In some implementations, a bidirectional signal pathway 328 across the isolation barrier 326 communicates a digital signal which includes, for example, at least classification control information.

In another specific embodiment depicted in FIG. 3, the PD controller 314 has an input line from a PoE signal and a connection to a classification resistor (RClass) which functions as the classification identification component 306. The PD 302 has an isolation barrier 326 separating the PD 302 into a high-voltage side 330 and a low-voltage side 332. The high-voltage side 332 can include the PD controller 314, the power switch 312, the disconnect 316, and a flash control component 334. The low-voltage side 332 can include the interface port 320, shown implemented as an I²C port 320. The I²C port 320 communicates with the non-volatile memory 310, illustratively a flash memory, through the isolation barrier 326 using a flash controller 336. The illustrative flash memory 310 holds a pair of re-classification registers 308. A first register 308A includes a single-bit Re-CL(1) bit field for storing the value 310A indicative of the new classification state and a three-bit New-Class(3) bit field for storing the new classification identifier 310C. A second register 308B includes a single-bit Rd-CL(1) bit field for storing the new classification override 310B and a three-bit New-Class(3) bit field that also holds the new classification identifier 310C.

During initial power-up, once the classification voltage is reached, the flash memory 310 is read. If the Re-CL(1) bit 310A and the Rd-CL(1) bit 310B are set, then the classification current is set as “New-Class”, according to the code of the New-Class(3) bit field 310C. Otherwise the external RClass 306 value is used for the classification current.

After classification, the Re-CL(1) bit 310A is reset. The Re-CL(1) bit 310A or Rd-CL(1) bit 310B can be set by a microprocessor 318 through the I²C port 320 in combination with the New-Class(3) value 310C.

Once the Re-CL(1) bit 310A or Rd-CL(1) bit 310B is set, the PD 302 takes the system 300 into a disconnect cycle for reclassification.

In the illustrative embodiment, the PoE system 300 enables a reclassification override option. The PoE system 300 thus includes another bit, the new classification override bit Rd-CL(1) bit 310B that can be used to set a new class irrespective of reclassification. The override can be imposed to program a class permanently. Because the illustrative technique always includes a read of the flash memory 310 upon power-up, the override can be implemented by addition of the bit in the memory 310.

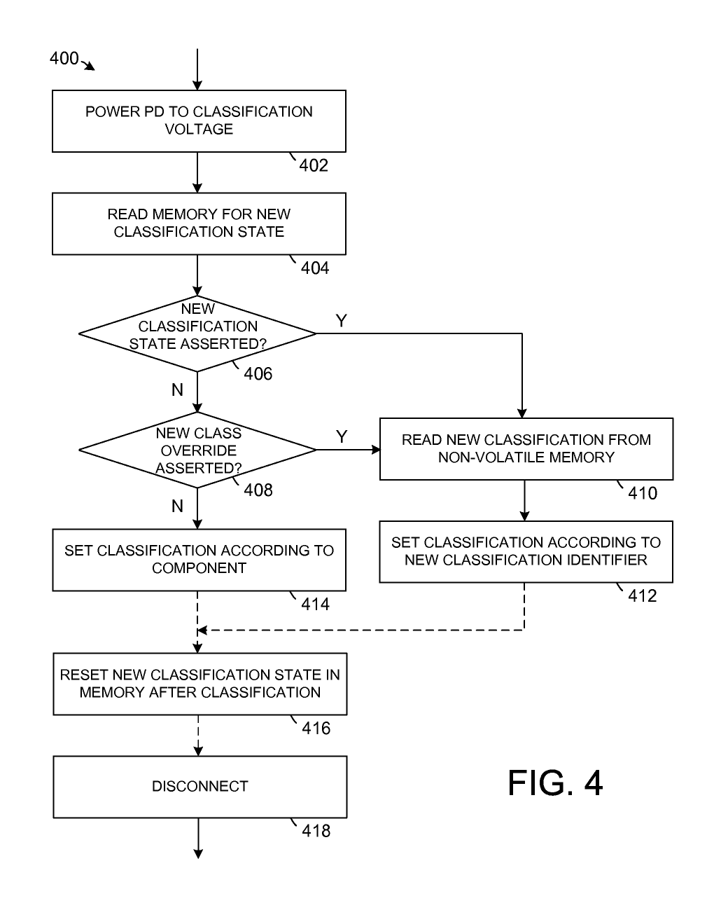

FIG. 4 is a flow chart showing an embodiment or aspect of a reclassification technique for determining a power level classification for a powered device (PD) coupled to a power sourcing equipment (PSE) in a power over Ethernet (PoE) system. The reclassification method 400 comprises powering 402 the powered device to a classification voltage and reading 404 a non-volatile memory indicative of a new classification state and indicative of a new classification override. If the new classification state is asserted 406 or the new classification override is asserted 408, the method 400 comprises reading 410 a new classification from a non-volatile memory holding an identifier of the new classification and setting 412 classification according to the new classification identifier. If the new classification state and the new classification override are not asserted, classification is set 414 according to a classification identification component.

In some implementations, the non-volatile memory indicative of the new classification state can be reset 416 after classification is set and a disconnect cycle performed 418 after the non-volatile memory indicative of the new classification state is reset.

The memory indicative of the new classification state, the new classification override, and the new classification identifier can be set by communication through the powered device (PD) to the non-volatile memory.

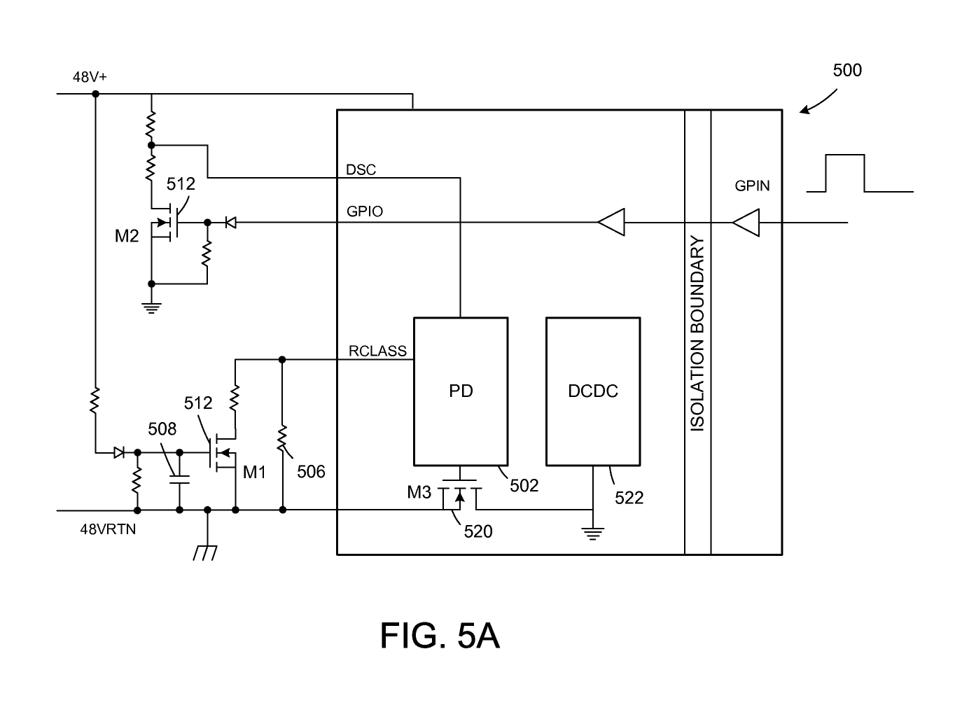

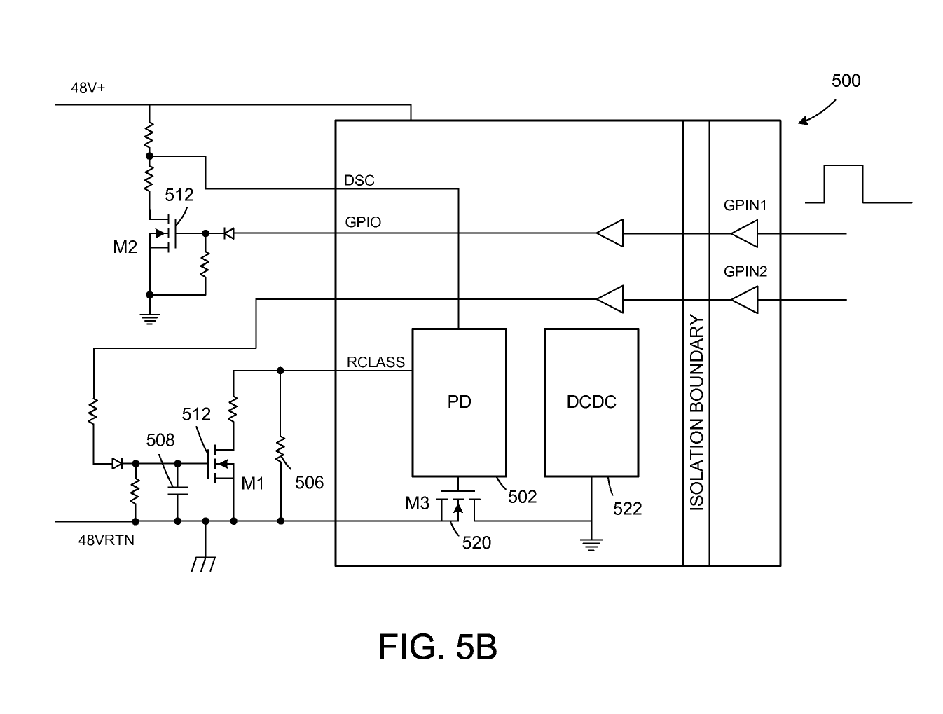

Referring to FIG. 5A, a schematic block diagram depicts another embodiment of a power over Ethernet system 500 that uses a capacitor as a memory element to temporarily hold a charge indicative of a change from a previous class status (classification state) to a new status. The illustrative Ethernet system 500 comprises a powered device (PD) 502 and a power sourcing equipment (PSE) 504 communicatively coupled to the PD 502. The Ethernet system 500 further comprises a classification identification component 506 coupled to the PD 502 and encodes a classification value, at least one switch 512 that controls powering of the PD 502, and a capacitor 508 operative as a memory element that temporarily stores charge to activate the switch or switches 512 for a predetermined time interval that causes the PSE 504 to change from a disconnect state to a reconnect/classification state. The PoE system 500 further comprise a logic that controls storing of the charge on the capacitor 508 and forces the PD 502 into a state to be disconnected by the PSE 504 wherein the PSE 504 reclassifies the PD 502 and reads the new classification from the PD 502.

The PoE system 500 depicted in FIG. 5A can replace a non-volatile memory such as a flash memory by storing information for usage in classification on the capacitor 508. The capacitor 508 is controlled so that the time constant of capacitor discharge is used to determine timing of temporary storage. In the illustrative embodiment, two control lines are configured including a first line (SET) for setting the capacitor 508 and a second line (DSC) that forces the powered device 502 to disconnect.

Another embodiment can have a single isolated general purpose input/output (GPIO) line for control. In an illustrative single control line approach, power-up occurs when the supplied voltage is, for example, 48 volts. The illustrative divider circuit applies the 48 volts through a diode D1 that places charge onto the capacitor 508 to force the switch 512, for example MOSFET M1, to an “on” or active state, which in turn activates a patch value resistor that changes the classification.

With the illustrative voltage divider, the voltage has to reach at least 37-40 volts to attain sufficient V_{GS} for the MOSFET M1 to turn on. Thus, MOSFET M1 will not turn on during classification but will rather turn on only after full power is applied. Once full power is applied, the capacitor 508 is charged. If the cable is unplugged and then reconnected, after a short time (for example, approximately a picosecond) the capacitor 508 is discharged so that memory is erased. In another sequence, the PD 502 can be disconnected and generally the PSE 504 responds in about 100 milliseconds and returns to the classification stage. Charge on the capacitor 508 remains for a suitable time, for example at least one-half second, so that for the subsequent classification stage in the power-up sequence the charge on the capacitor 508 has changed the classification value resistor and the new classification is evoked. Once the new classification is activated, the sequence continues to the full power mode for which the capacitor 508 is again recharged, a moot condition since the new classification is already invoked.

To return to the original classification, the cable can be unplugged for a sufficient time, for example about one second, and the charge is removed from the capacitor memory. The cable can be replugged and the original classification is restored.

Accordingly, the capacitor 508 functions as a memory element that stores charge to force a switch such as a field effect transistor (FET) or metal-oxide semiconductor FET (MOSFET) into an active state for a predetermined time interval that is sufficient for the PSE 504 to pass from a disconnected stage to a reconnect/classification stage.

Another aspect of operation of the PoE system 500 is a disconnect action that forces the PD 502 into a state to be disconnected by the PSE 504 so that the PSE 504 is forced to reclassify the device 502 and thus reads the new classification that has been set. In an illustrative method, the logic can be implemented as a processor which sends a signal, for example over a general-purpose input/output (GPIO) line, to control a switch or switches 512 to control disconnect. In various embodiments, the processor can send control signals through a bridge, a manual GPIO, or other pathway. In some implementations, the control signals can be passed across an isolation boundary, for example using digital isolation, optical isolation, or other isolation.

The disconnect line (DSC) can be used when local power is available on a power over Ethernet (PoE) or powered device (PD) application and therefore power sourced by a power sourcing equipment (PSE) is unnecessary. Control signals can be passed on the disconnect line to disconnect power sourced by the PSE. In an example implementation, a local power detect (LDET) signal can be used for DSC since availability of local power enables disconnection of PSE sourced power. DSC is connected to control a power switch 520, for example MOSFET M3 as shown, and can disable the power switch 520 so that no current passes to a DCDC converter 522 and attached circuitry. Main power signature (MPS) or maintenance current, which is required by standards to be at least 5 milliamps, thus falls below the standard so that the PSE 504 detects the current deficiency, determines that the circuit is cut off, and generates control signals to perform the disconnect operation. PSE 504 performs the disconnect then senses for the signature, which remains present, and then determines whether reclassification can be performed.

In an example implementation, initially a charge can be stored on the capacitor 508 connecting MOSFET M1 512 and a disconnect (DSC) can be created by sending a signal via an isolator such as a digital isolator or optical isolator to pull down a disconnect (DSC) pin that disables a power switch 520, which in turn reduces maintenance current (MPS) to less than the specified value of 5 milliamps which causes the PSE 504 to disconnect.

The disconnect (DSC) passes control to the power switch 520, applying the 48 volts through the power switch 520 to the DCDC converter 522 and to a load on the other side of the DCDC converter 522. When the power switch 520 is turned off, the entire load is no longer connected.

The illustrative PoE system 500 implements a direct current (DC) disconnect operation. In other embodiments, alternative current (AC) disconnect can be performed.

In the illustrative embodiment, a single digital I/O signal from the logic is attached to the switch 512 to pull down the disconnect signal. Various other configurations can be implemented. In one variation, shown in FIG. 5B, two control signals can be applied including a first for controlling the disconnect signal and a second that controls direct application of the 48 volt line to the capacitor, connecting any selected voltage such as a high voltage, 5 volts, or any selected voltage to a switch for charging the capacitor. The second control line enables the logic such as a processor or controller to directly control application of a voltage to the switch rather than simply having the supply applying the voltage.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, various aspects or portions of a network interface are described including several optional implementations for particular portions. Any suitable combination or permutation of the disclosed designs may be implemented.

What is claimed is:

1. A method for determining a power level classification for a powered device (PD) coupled to a power sourcing equipment (PSE) in a power over Ethernet (PoE) system comprising:
powering the powered device to a classification voltage;
reading a non-volatile memory indicative of a new classification state;
if the new classification state is asserted, reading a new classification from a non-volatile memory holding an identifier of the new classification and setting classification according to the new classification identifier; and
if the new classification state is not asserted, setting classification according to a classification identification component.

2. The method according to claim 1 further comprising:
resetting the non-volatile memory indicative of the new classification state after classification is set.

3. The method according to claim 2 further comprising:
performing a disconnect cycle after the non-volatile memory indicative of the new classification state is reset.

4. The method according to claim 1 further comprising:
setting the memory indicative of the new classification state and the new classification identifier by communication through the powered device (PD) to the non-volatile memory.

5. The method according to claim 1 further comprising:
operating the powered device (PD);
detecting connection of an additional module to the PD;
requesting reclassification;
asserting the non-volatile memory indicative of the new classification state;
setting the non-volatile memory identifying the new classification; and
powering down the PD.

6. The method according to claim 1 further comprising:
powering the powered device (PD) and the non-volatile memory at a high voltage;
powering the power sourcing equipment (PSE) at a low voltage lower than the high voltage; and
isolating the high voltage from the low voltage at an isolation barrier.

7. The method according to claim 1 further comprising:
communicating a digital signal bidirectionally across the isolation barrier, the digital signal comprising at least classification control information.

8. A power over Ethernet (PoE) system comprising:
a powered device (PD);
a power sourcing equipment (PSE) communicatively coupled to the PD;
a classification identification component coupled to the PD encoding a classification value;
a reclassification register in a non-volatile memory storing a value indicative of a new classification state and a new classification identifier; and
a power switch that powers the powered device to a classification voltage;
a PD controller coupled to the powered device that reads the value indicative of the new classification state and, if the new classification state is asserted, reads the new classification identifier and sets classification according to the new classification identifier and, if the new classification state is not asserted, sets classification according to the classification identification component.

9. The system according to claim 8 further comprising:
a disconnect device coupled to the powered device (PD) controller that disconnects power to the PD under PD controller control;
a processor communicatively coupled to the PD; and
an interface port in the PD communicatively coupled between the processor and the non-volatile memory.

10. The system according to claim 8 further comprising:
the powered device (PD) controller further resetting the non-volatile memory indicative of the new classification state after classification is set.

11. The system according to claim 10 further comprising:
the powered device (PD) controller further activating a disconnect cycle after the non-volatile memory indicative of the new classification state is reset.

12. The system according to claim 8 further comprising:
a processor communicatively coupled to the PD; and
an interface port in the PD communicatively coupled between the processor and the non-volatile memory, the processor setting the memory indicative of the new classification state and the new classification identifier by communication through the powered device (PD) to the non-volatile memory.

13. The system according to claim 8 further comprising:
a sensor coupled to the processor that detects connection of an additional module to the powered device (PD) during PD operation;
the processor responsive to the detected connection by requesting reclassification of the PD wherein the reclassification register is updated with the non-volatile memory indicative of the new classification state asserted and the new classification identifier set.

14. The system according to claim 8 further comprising:
an isolation barrier isolating a high voltage from a low voltage lower than the high voltage wherein the powered device (PD) and the non-volatile memory are powered at the high voltage, and the power sourcing equipment (PSE) is powered at the low voltage; and
a bidirectional signal pathway across the isolation barrier that communicates a digital signal comprising at least classification control information.

15. A method for determining a power level classification for a powered device (PD) coupled to a power sourcing equipment (PSE) in a power over Ethernet (PoE) system comprising:
powering the powered device to a classification voltage;
reading a non-volatile memory indicative of a new classification state and indicative of a new classification override;
if the new classification state is asserted or the new classification override is asserted, reading a new classification from a non-volatile memory holding an identifier of the new classification and setting classification according to the new classification identifier; and
if the new classification state and the new classification override are not asserted, setting classification according to a classification identification component.

16. The method according to claim 15 further comprising:
resetting the non-volatile memory indicative of the new classification state after classification is set; and
performing a disconnect cycle after the non-volatile memory indicative of the new classification state is reset.

17. The method according to claim 15 further comprising:
setting the memory indicative of the new classification state, the new classification override, and the new classification identifier by communication through the powered device (PD) to the non-volatile memory.

18. The method according to claim 15 further comprising:
operating the powered device (PD);
detecting connection of an additional module to the PD;
requesting reclassification;
asserting the non-volatile memory indicative of the new classification state or the new classification override;
setting the non-volatile memory identifying the new classification; and
powering down the PD.

19. The method according to claim 15 further comprising:
powering the powered device (PD) and the non-volatile memory at a high voltage;
powering the power sourcing equipment (PSE) at a low voltage lower than the high voltage;
isolating the high voltage from the low voltage at an isolation barrier; and
communicating a digital signal bidirectionally across the isolation barrier, the digital signal comprising at least classification control information.

20. A power over Ethernet (PoE) system comprising:
a powered device (PD);
a power sourcing equipment (PSE) communicatively coupled to the PD;
a classification identification component coupled to the PD encoding a classification value;
a reclassification register in a non-volatile memory storing a value indicative of a new classification state, a value indicative of a new classification override, and a new classification identifier; and
a power switch that powers the powered device to a classification voltage;
a PD controller coupled to the powered device that reads the value indicative of the new classification state and, if the new classification state or the new classification override is asserted, reads the new classification identifier and sets classification according to the new classification identifier and, if the new classification state is not asserted, sets classification according to the classification identification component.

21. The system according to claim 20 further comprising:
a disconnect device coupled to the powered device (PD) controller that disconnects power to the PD under PD controller control;
a processor communicatively coupled to the PD; and
an interface port in the PD communicatively coupled between the processor and the non-volatile memory, the processor setting the memory indicative of the new classification state, the new classification override, and the new classification identifier by communication through the powered device (PD) to the non-volatile memory.

22. The system according to claim 20 further comprising:
the powered device (PD) controller resetting the non-volatile memory indicative of the new classification state after classification is set and activating a disconnect cycle after the non-volatile memory indicative of the new classification state is reset.

23. The system according to claim 20 further comprising:
a sensor coupled to the processor that detects connection of an additional module to the powered device (PD) during PD operation;
the processor responsive to the detected connection by requesting reclassification of the PD wherein the reclassification register is updated with the non-volatile memory indicative of the new classification state asserted and the new classification identifier set.

24. The system according to claim 20 further comprising:
an isolation barrier isolating a high voltage from a low voltage lower than the high voltage wherein the powered device (PD) and the non-volatile memory are powered at the high voltage, and the power sourcing equipment (PSE) is powered at the low voltage; and
a bidirectional signal pathway across the isolation barrier that communicates a digital signal comprising at least classification control information.

25. A power over Ethernet (PoE) system comprising:
a powered device (PD);
a power sourcing equipment (PSE) communicatively coupled to the PD;
a classification identification component coupled to the PD encoding a classification value;
at least one switch that controls powering of the PD;
a capacitor operative as a memory element that temporarily stores charge to activate the at least one switch for a predetermined time interval that causes the PSE to change from a disconnect state to a reconnect/classification state; and
a logic that controls storing of the charge on the capacitor and forces the PD into a state to be disconnected by the PSE wherein the PSE reclassifies the PD and reads the new classification from the PD.
